(19) United States
(12) Patent Application Publication
(10) Pub. No.: US 2005/0194166 A1
(43) Pub. Date: Sep. 8, 2005

(54) High torque electromotive tool

(75) Inventor: Wu-Lung Chu, Ta Li City (TW)

Correspondence Address: NIKOLAI & MERSEREAU, P.A., 900 SECOND AVENUE SOUTH, SUITE 820, MINNEAPOLIS, MN, 55402, US

(73) Assignee: GOODTI INDUSTRIAL CO., LTD., Taichung (TW)

(21) Appl. No.: 11/120,357

(22) Filed: May 3, 2005

Related U.S. Application Data
(63) Continuation-in-part of application No. 10/457,712, filed on Jun. 10, 2003.

(51) Int. Cl. H02K 16/00; H02K 16/02

(52) U.S. Cl. 173/217

(57) ABSTRACT

An electromotive tool includes a housing, a motor, an electric control device, and a circuit device connected to the electric control device in a parallel manner. The electric control device includes a battery set. The circuit device includes an electric double layer capacitor connected to the battery set of the electric control device in a parallel manner. Thus, the electric double layer capacitor supplies a relatively higher electric current to the motor so that the output shaft of the motor produces a relatively higher torque instantaneously.

### CROSS-REFERENCES TO RELATED APPLICATIONS

The present invention is a continuation-in-part application of the co-pending U.S. Ser. No. 10/457,712.

### BACKGROUND OF THE INVENTION

1. Field of the Invention

The present invention relates to an electromotive tool, and more particularly to a high torque electromotive tool.

2. Description of the Related Art

A conventional electromotive tool comprises a housing, a motor mounted in the housing and having an output shaft protruded outward from the housing, and a battery set mounted in the housing and includes a plurality of rechargeable batteries connected to the motor to supply an electric power to the motor so as to rotate the output shaft of the motor. However, the charging and discharging current of the rechargeable batteries is limited, so that the electric power supplied by the battery set to the motor is limited. Thus, the conventional electromotive tool has a smaller output torque. In addition, the electric power supplied by the battery set to the motor is used during a short period of time, thereby causing inconvenience to the operator. Further, each of the rechargeable batteries has a shorter lifetime, thereby increasing costs of the conventional electromotive tool.

The closest prior art references of the conventional electromotive tool were disclosed in U.S. Pat. No. 3,525,912 to Wallin, U.S. Pat. No. 5,426,561 to Yen et al. and U.S. Pat. No. 6,318,874 to Matsunaga.

### SUMMARY OF THE INVENTION

The primary objective of the present invention is to provide an electromotive tool that produces a relatively higher torque instantaneously.

Another objective of the present invention is to provide an electromotive tool, wherein the electric double layer capacitor supplies a relatively higher electric current to the motor so that the output shaft of the motor produces a relatively higher torque instantaneously.

A further objective of the present invention is to provide an electromotive tool, wherein the electric double layer capacitor is charged and discharged during rapidly, thereby facilitating the operator operating the electromotive tool.

A further objective of the present invention is to provide an electromotive tool, wherein the illuminating light is located adjacent to the output shaft of the motor and parallel with the output shaft of the motor to provide an illuminating effect to the output shaft of the motor.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an electromotive tool in accordance with the preferred embodiment of the present invention; and

FIG. 2 is a plan cross-sectional view of the electromotive tool.

### DETAILED DESCRIPTION OF THE INVENTION

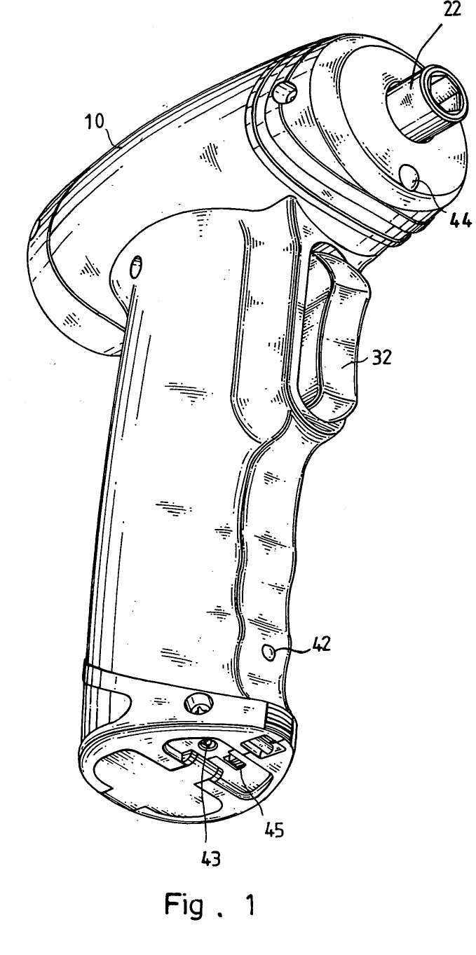

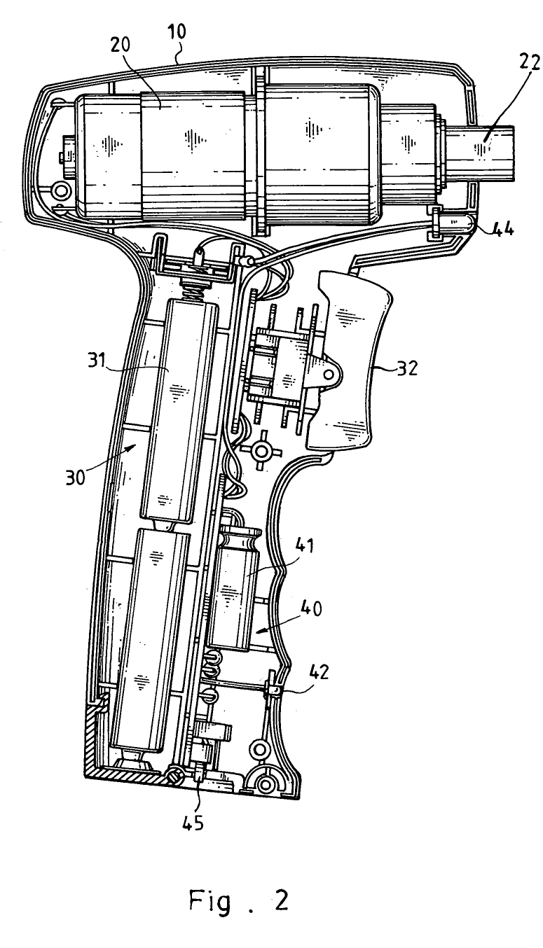

Referring to FIGS. 1 and 2, an electromotive tool in accordance with the preferred embodiment of the present invention comprises a housing 10, a motor 20 mounted in the housing 10 and having an output shaft 22 protruded outward from the housing 10, an electric control device 30 mounted in the housing 10 to supply an electric power to the motor 20, and a circuit device 40 mounted in the housing 10 to supply an electric power to the motor 20 and connected to the electric control device 30 in a parallel manner.

The electric control device 30 includes a battery set 31 mounted in the housing 10 and connected to the motor 20 to supply an electric power to the motor 20, and a push button 32 protruded outward from the housing 10 and connected to the battery set 31 to control operation of the battery set 31.

The circuit device 40 includes an electric double layer capacitor (EDLC) 41 mounted in the housing 10 and connected to the battery set 31 of the electric control device 30 in a parallel manner, a charging plug 43 mounted on a bottom of the housing 10 and exposed to an outside of the housing 10, a charging indicator 42 mounted on and protruded outward from a lower portion of the housing 10 and connected to the charging plug 43, an illuminating light 44 mounted on an upper portion of the housing 10, and a control switch 45 mounted on the bottom of the housing 10 and connected to the illuminating light 44 to control operation of the illuminating light 44.

The electric double layer capacitor 41 is connected to the motor 20 to supply an electric power to the motor 20. When the electric double layer capacitor 41 is charged or discharged, the electric double layer capacitor 41 has a physical reaction without accompanying a chemical reaction, so that the electric double layer capacitor 41 has an instantaneously amplified feature to produce a relatively higher electric current during the charging and discharging process. Thus, the electric double layer capacitor 41 supplies a relatively higher electric current to the motor 20 so that the output shaft 22 of the motor 20 produces a relatively higher torque instantaneously.

The charging plug 43 is connect to the electric double layer capacitor 41 and the battery set 31 for charging the electric double layer capacitor 41 and the battery set 31.

The charging indicator 42 is connected to the charging plug 43 to provide an indication function during the charging process of the electric double layer capacitor 41 and the battery set 31.

The illuminating light 44 is a light emitting diode (LED) having greater lightness, smaller electric loss and longer lifetime. Preferably, the illuminating light 44 is located adjacent to the output shaft 22 of the motor 20 and parallel with the output shaft 22 of the motor 20 to provide an illuminating effect to the output shaft 22 of the motor 20.

When in use, the charging plug 43 is inserted into a receptacle (not shown) of a charger (not shown) for charging the electric double layer capacitor 41 and the battery set 31. At this time, the electric double layer capacitor 41 has an instantaneously amplified feature to produce a relatively higher electric current so that the electric double layer capacitor 41 reaches a saturated state during a shorter period of time before the battery set 31 reaches a saturated state. Thus, the electric double layer capacitor 41 can supply an electric power to the motor 20 instantaneously for use with an operator simultaneously, thereby facilitating the operator operating the electromotive tool. In addition, the electric double layer capacitor 41 has a physical reaction without accompanying a chemical reaction, so that the electric double layer capacitor 41 is used during a longer period of time, thereby enhancing the lifetime of the electric double layer capacitor 41.

Accordingly, the electric double layer capacitor 41 supplies a relatively higher electric current to the motor 20 so that the output shaft 22 of the motor 20 produces a relatively higher torque instantaneously. In addition, the electric double layer capacitor 41 is charged and discharged during rapidly, thereby facilitating the operator operating the electromotive tool. Further, the illuminating light 44 is located adjacent to the output shaft 22 of the motor 20 and parallel with the output shaft 22 of the motor 20 to provide an illuminating effect to the output shaft 22 of the motor 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An electromotive tool, comprising:
a housing;
a motor mounted in the housing and having an output shaft protruded outward from the housing;
an electric control device mounted in the housing to supply an electric power to the motor;
a circuit device mounted in the housing to supply an electric power to the motor and connected to the electric control device in a parallel manner; wherein
the electric control device includes a battery set mounted in the housing and connected to the motor to supply an electric power to the motor;
the circuit device includes an electric double layer capacitor mounted in the housing and connected to the battery set of the electric control device in a parallel manner.

2. The electromotive tool in accordance with claim 1, wherein the electric control device further includes a push button protruded outward from the housing and connected to the battery set to control operation of the battery set.

3. The electromotive tool in accordance with claim 1, wherein the electric double layer capacitor is connected to the motor to supply an electric power to the motor.

4. The electromotive tool in accordance with claim 1, wherein when the electric double layer capacitor is charged or discharged, the electric double layer capacitor has a physical reaction without accompanying a chemical reaction, so that the electric double layer capacitor has an instantaneously amplified feature to produce a relatively higher electric current during the charging and discharging process.

5. The electromotive tool in accordance with claim 1, wherein the electric double layer capacitor supplies a relatively higher electric current to the motor so that the output shaft of the motor produces a relatively higher torque instantaneously.

6. The electromotive tool in accordance with claim 1, wherein the circuit device further includes a charging plug connect to the electric double layer capacitor and the battery set for charging the electric double layer capacitor and the battery set.

7. The electromotive tool in accordance with claim 6, wherein the charging plug is mounted on a bottom of the housing and exposed to an outside of the housing.

8. The electromotive tool in accordance with claim 6, wherein the circuit device further includes a charging indicator connected to the charging plug to provide an indication function during the charging process of the electric double layer capacitor and the battery set.

9. The electromotive tool in accordance with claim 8, wherein the charging indicator is mounted on and protruded outward from a lower portion of the housing.

10. The electromotive tool in accordance with claim 1, wherein the circuit device further includes an illuminating light mounted on an upper portion of the housing and located adjacent to the output shaft of the motor.

11. The electromotive tool in accordance with claim 10, wherein the illuminating light is parallel with the output shaft of the motor to provide an illuminating effect to the output shaft of the motor.

12. The electromotive tool in accordance with claim 10, wherein the circuit device further includes a control switch mounted on the bottom of the housing and connected to the illuminating light to control operation of the illuminating light.

13. The electromotive tool in accordance with claim 1, wherein the illuminating light is a light emitting diode.

14. The electromotive tool in accordance with claim 1, wherein the electric double layer capacitor has an instantaneously amplified feature to produce a relatively higher electric current so that the electric double layer capacitor reaches a saturated state during a shorter period of time before the battery set reaches a saturated state.

15. The electromotive tool in accordance with claim 1, wherein the electric double layer capacitor can supply an electric power to the motor instantaneously.

16. The electromotive tool in accordance with claim 1, wherein the electric double layer capacitor supplies a relatively higher electric current to the motor so that the output shaft of the motor produces a relatively higher torque instantaneously.
